(19) United States
(12) Patent Application Publication
(10) Pub. No.: US 2025/0256548 A1
(43) Pub. Date: Aug. 14, 2025

(54) METHOD AND SYSTEM FOR CONTROLLING A CLIMATE CONTROL SYSTEM OF A VEHICLE USING A DUCT PURGE STRATEGY

(71) Applicant: FCA US LLC, Auburn Hills, MI (US)

(72) Inventors: Mark E Stout, Auburn Hills, MI (US); Travis D. Bechtel, Goodrich, MI (US)

(21) Appl. No.: 18/441,079

(22) Filed: Feb. 14, 2024

(51) Int. Cl. B60H 1/00; B60H 1/26

(52) U.S. Cl. CPC B60H 1/00849; B60H 1/0075; B60H 1/00807; B60H 1/26

(57) ABSTRACT

A system and method of controlling cabin air within a vehicle includes determining an elevated thermal level within a vehicle, opening a duct purge valve based on the elevated thermal level and communicating air through a primary duct to a purge duct through the purge valve.

### FIELD

The present disclosure relates to a climate control system for a vehicle and, more specifically, to a method for purging the ducts upon start-up to increase comfort of the occupant.

### BACKGROUND

This section provides background information related to the present disclosure which is not necessarily prior art.

Climate control systems in vehicles require input for controlling the conditions in the occupant area. Vehicles may have climate control systems for one or more passengers. That is, the climate control system may have individual controls for controlling the driver front seat, the passenger front seat and one or more rear seats. Climate control settings include the temperature and, airflow or fan speed desired by the occupant. The vents through which the conditioned air travels may also be directed at or away from the occupant or the different parts of the vehicle.

Air conditioning portion of the climate control system use a blower fan to push air through an evaporator for cooling and drying, then flow it through a series of heating, ventilation and air conditioning (HVAC) ducts toward one or multiple air outlets in the vehicle cabin. The air inside the ducts is subject to heating by the ambient environment when the climate control system is turned off. Upon startup, the stagnant heated air must be pushed out of the HVAC ducts before cool air from the evaporator can reach the occupant. The application of hot air in an already hot vehicle cabin may cause discomfort for the occupant. Additionally, humans are known to be most sensitive to overheating at the head and face region, which is often the warmest portion of a vehicle cabin after the vehicle has been soaking in sunlight for a prolonged amount of time.

Battery electric vehicles suffer from limited range, a problem that is further exacerbated by the significant weight that a battery adds to a vehicle. Thus, a need exists to increase efficiency and decrease the size of in-vehicle air conditioning systems.

### SUMMARY

This section provides a general summary of the disclosure, and is not a comprehensive disclosure of its full scope or all of its features.

In one aspect of the disclosure, a method of controlling cabin air within a vehicle includes determining an elevated thermal level within a vehicle, opening a duct purge valve based on the elevated thermal level and communicating air through a primary duct to a purge duct through the purge valve.

In another aspect of the disclosure, a system includes an elevated thermal level detection circuit determining an elevated thermal level within a cabin of a vehicle, a primary duct having a controllable vent and a duct purge valve, a purge duct coupled to the primary duct at the duct purge valve and a blower moving air within the primary duct. A controller, in a duct purge state, closes the controllable vent and controls the duct purge valve so air through the primary duct is communicated through the purge valve to the purge duct.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1A is a high-level schematic view of a vehicle having the climate control system according to the present disclosure.

FIG. 1B is an enlarged view of a vent 42 in an open position.

FIG. 1C is a front view of a vent in the closed position.

FIG. 1D is a high-level diagrammatic side view of a cabin of a vehicle.

FIG. 1E is a thermal plot of stratified air in a vehicle cabin.

FIG. 1F is a front perspective view of a vent having horizontal and vertical louvers.

FIG. 1G is a side view of the vent of FIG. 1F.

FIG. 2 is a block diagrammatic view of the controller of the vehicle.

FIG. 3 is a high-level flowchart of a method for operating the system.

FIG. 4 is a high-level diagrammatic view of the duct system of the vehicle.

FIG. 5A is a flowchart of a method for initiating the operation of the system.

FIG. 5B is a flowchart of a method for purging the ducts.

FIG. 5C is a flowchart of a method for de-stratifying the cabin.

FIG. 5D is a flowchart of a method for directing cooling the occupant.

Corresponding reference numerals indicate corresponding parts throughout the several views of the drawings.

### DETAILED DESCRIPTION

Example embodiments will now be described more fully with reference to the accompanying drawings.

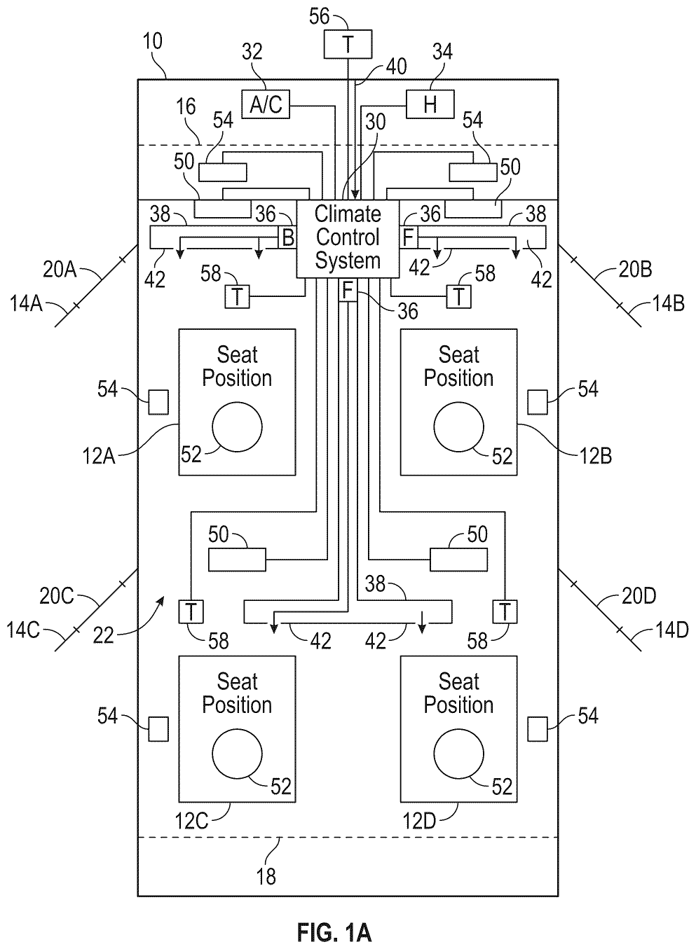

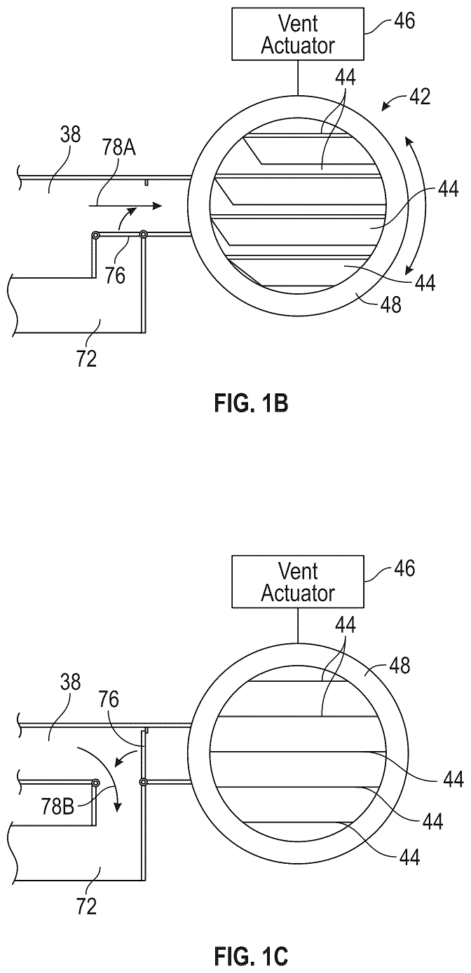

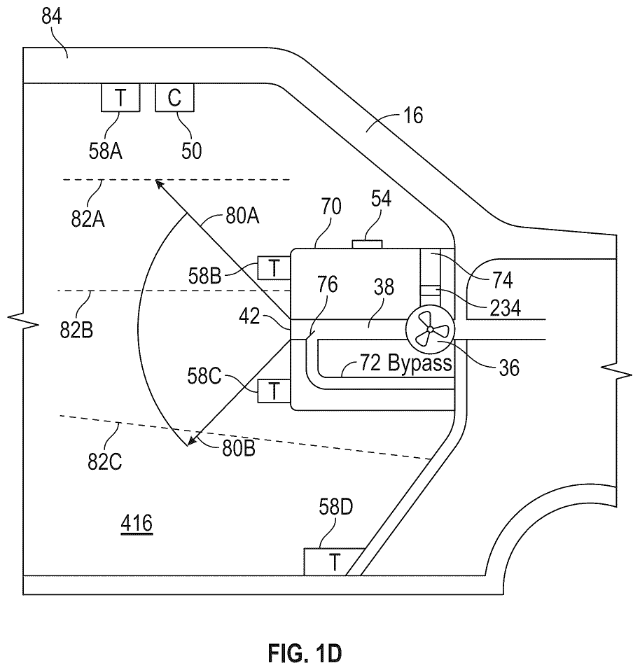

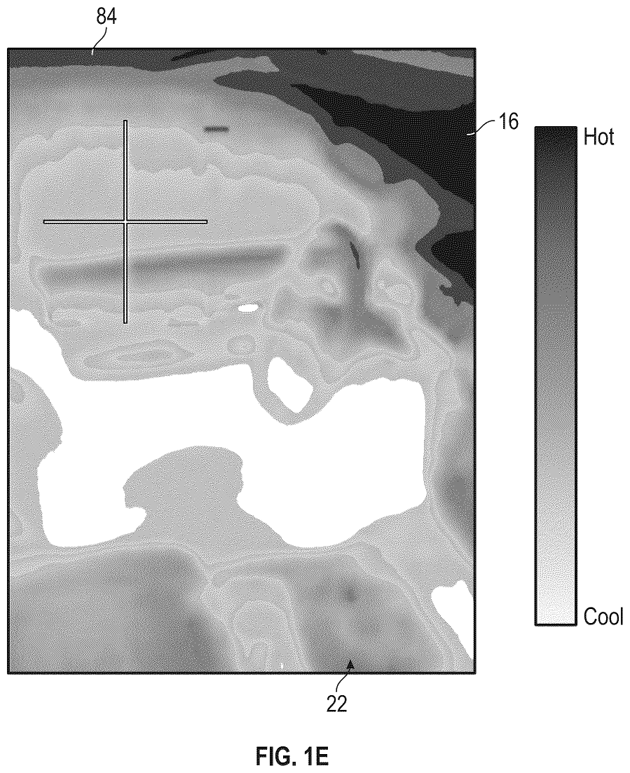

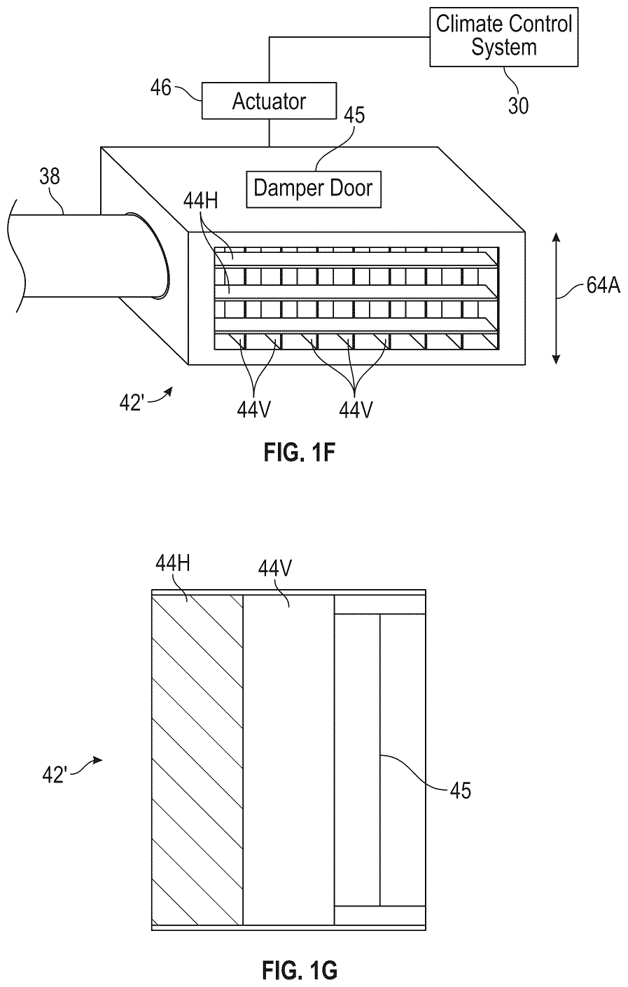

Referring now to FIG. 1A, a vehicle 10 is illustrated having a plurality of seating positions 12A, 12B, 12C and 12D. Seating position 12A, in this example, is the driver position. The seating position 12B is the front passenger position. Seat position 12C is the rear left passenger position and seat position 12D is in the rear right passenger position. The vehicle 10 has a plurality of doors 14A, 14B, 14C and 14D adjacent to each of the seat positions 12A-12D. Of course, more seat positions such as a position between seat positions 12A and 12B, between 12C and 12D and behind 12C and 12D may also be provided in the vehicle 10.

The vehicle 10 also has a windshield 16, a rear window 18 and door windows 20A-20D that correspond to the doors 14A-14D, respectively. The amount of solar load from sunshine entering the cabin 22 varies considerably based upon the position and angle of the sun relative to the vehicle. Of course, other windows including a sunroof may be included within the vehicle.

A climate control system 30 is also included within the vehicle. The climate control system 30 is in communication with an air conditioning system 32 and a heater system 34 to control the outlet temperature of the vents. The air conditioning system 32 may comprise an air conditioning compressor coupled to the engine by way of a belt. The air conditioning system 32, in an electric vehicle, may be an electric motor that operates a compressor to generate cooling fluid.

The heater system 34 may be coupled to an engine to remove heat from the engine and provide it to the cabin 22. The heater system 34 may also be a resistive heater or combinations of a resistive heater and an engine heater.

One or more fans or blowers 36 may be used to move air from the air conditioning system 32, the heater system 34 and possibly from air from outside the vehicle as well. The air from the outside of the vehicle is indicated by the arrow 40. The blower 36 communicates air through ducts 38. Each individual position may have its own duct or, for example, the seat positions 12C and 12D in the rear of the vehicle may spare a common duct. Various possibilities are available for different vehicles.

The ducts 38 have vents 42 through which controller air is communicated to the cabin 22. Two vents 42 are illustrated directed to the seat positions 12A and 12B. One vent is directed at the seating positions 12C and 12D. However, various numbers of vents 42 in various positions may be provided such as at the legs, at various positions of the torso, the arms and the like. The direction of the vents 42 may be controlled laterally, longitudinally, and vertically. The opening and closing of the vents 42 may also be controlled.

Referring now to FIGS. 1B and 1C, the vents 42 illustrated in FIG. 1A are merely represented by openings. The vents 42 have louvers 44 that are coupled to a vent actuator 46. The vent actuator 46 is in communication with the climate control system 30. The climate control system 30 may control the actuator 46 to move the vents 42 and louvers 44 of the vents 42 into desired positions. That is, the louvers 44 are movable in an open position, a closed position (as shown in FIG. 1C). Partial opening and closing of the louvers 44 allow direction. The actuator 46 may rotate a housing 48 so that an upward direction and downward direction as well as in a rightward direction or leftward direction (and angular directions therebetween may be achieved). That is, the actuator 46 may move the louvers 44 into various positions including a closed position as illustrated in FIG. 1C. By opening and closing the louvers 44, directing the louvers 44, controlling the fan speed, controlling the air temperature within the ducts 38, occupant comfort can be controlled precisely. Of course, multiple actuators 60 and multiple vents 42 may be located at various positions around the occupants 52.

Inputs to the climate control system 30 include thermal image devices such as thermal cameras 50 that are positioned to view the seating positions 12A-12D. The thermal cameras 50 generate thermal camera signals corresponding to a thermal image of the seating positions 12A-12D. That is, the thermal cameras 50 generate thermal images of the occupants 52 and various aspects of the occupants 52 as will be described in further detail below. The thermal cameras 50 generate thermal image signals that correspond to surface temperatures. Hot spots may therefore be identified. The images are communicated to the climate control system 30 and are processed by a microprocessor therein. Various analysis is used to control the various aspects of the climate control system including the air conditioning 32, the heater system 34, the blower fans 36 and the like. Cooling through air conditioning is the specific focus herein.

The climate control system 30 also is coupled to sun load sensors 54. The sun load sensors 54 generate a sun load signal corresponding to the sun load at the position at which the sun load sensors 54 are mounted. Other sun load sensors 54 are not connected to the climate control system as illustrated in FIG. 1A. Those in the art will understand that they are actually coupled to the climate control system 30 but for simplicity of illustration purposes are not illustrated as such. The sun load sensors 54 may be positioned in front of the first and second seating positions 12A, 12B, on the sides of the seating positions 12A, 12B. in addition, sun load sensors 54 may be located in other systems such as on the outside of seating positions 12C, 12D.

An external or ambient temperature sensor 56 may generate a temperature signal corresponding to the exterior temperature of the vehicle and communicate the exterior temperature signal to the climate control system 30.

Although one thermal camera 50 is shown for each seat position 12A-12D, multiple cameras 50 in multiple positions may be used.

Cabin temperature sensors 58 may be located at various positions throughout the cabin 22. The temperature sensors 58 generate a cabin temperature signal adjacent thereto including at the various seating positions 12A-12D. One temperature sensor may be used. However, multiple sensors may be distributed in the cabin as described below.

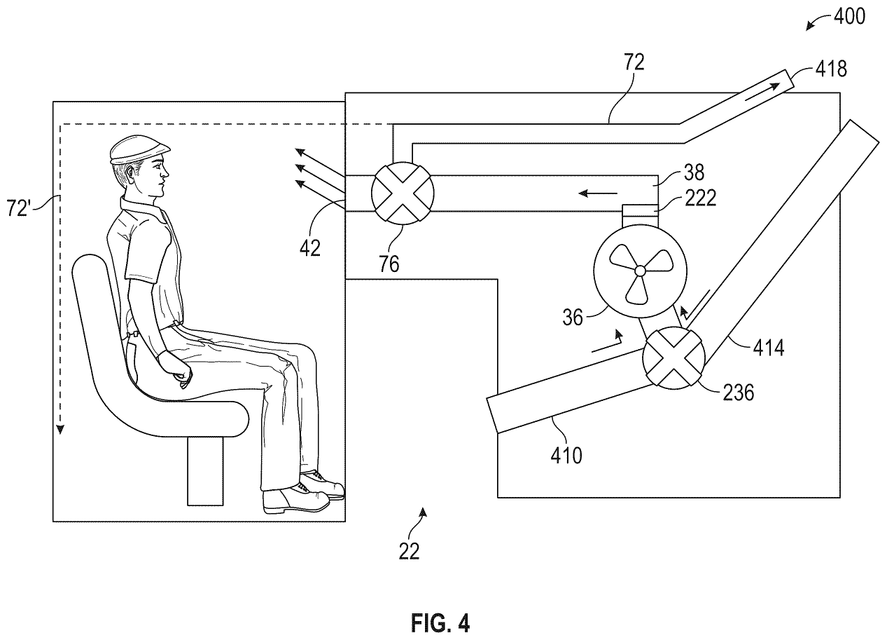

Referring now also to FIG. 1D, a simplified version of the primary duct 38 disposed within an instrument panel 70 is set forth. The instrument panel 70 of FIG. 1D is a simple cutaway view showing the primary duct 38, a purge duct 72 and a defroster duct 74. The purge duct 72 has a duct purge valve 76 that opens and closes as illustrated by contrasting FIGS. 1B and 1C. When the duct purge valve 76 is closed, as illustrated in FIG. 1B, air is communicated through the primary duct 38 and through the vent 42 as indicated by the arrows 78A. In contrast, FIG. 1C shows the duct purge valve 76 in an open position to allow air from the primary duct 38 to flow into the purge duct 72 as indicated by the arrow 78B. The purge duct 72 may communicate heated air outside the vehicle 10 or to a location within the vehicle where the hot air can be recycled but does not act on the occupants. See path 72′ illustrated in FIG. 4 as described below.

As mentioned above, the vent 42 may be directed in a variety of positions. Vent 42 may be positioned to direct air in an upward position 80A and a downward position 80B as indicated by the arrows in FIG. 1D. By positioning the louvers 44 in the upward direction indicated by arrow 80A, stratification indicated by the dotted lines 82A, 82B, and 82C may be reduced (destratification). Stratification refers to the different levels of temperature of the air in the vehicle. Each level may be a range of several degrees. Naturally the highest temperatures are higher in the cabin 22 of the vehicle 10. The thermal camera 50 may also be used to determine stratification. However, temperature sensors located throughout the cabin 22 such as the temperature sensor 58A located at or near the roof 84 of the vehicle, temperature sensor 58B located near the top of the instrument panel 70, a temperature sensor 58C located near the bottom or below the instrument panel 70 and a temperature sensor 58D located near the bottom of the vehicle. By monitoring the difference in the various temperatures indicated by the cabin temperature sensor 58A-58D, the amount of stratification may be determined. Stratification may be determined by a temperature difference between one or more of the temperature sensors 58A-58D. Typically, in a still vehicle, the temperature at the temperature sensor 58A will be higher. However, when convection is occurring under the operation of the blower 36, a reduction in stratification (destratification) and therefore an evening out of the temperature may occur. A reduction in the maximum temperature differences may occur.

The blower 36 is designed to operate at one or more speeds that correspond to an amount of volume displaced. The blower fan speed may correspond to a standard cubic feet per minute (SCFM) flow rate. Knowing the volume within the primary duct 38, the flow rate and volume may therefore be used to calculate how long the blower is to be operated (a predetermined time) in order to replace the predetermined volume of heated air within the primary duct 38. It should be noted that although the primary duct 38 is illustrated in the instrument panel, various other ducts directed at different seating positions may be configured and controlled in the same way. That is, FIG. 1A shows the duct 38 communicating air to various rearward seating positions. The blower 36 may therefore operate together with a purge duct 72 to replace the air in the entire primary duct 38.

Referring now to FIG. 1E, a thermal plot illustrating stratified air in a vehicle cabin. Heated air is shown in the area of the roof 84 as heated air rises. Cooler air is shown lower in the cabin 22. Stratified air as shown is undesirable for the occupant as the head region that is most sensitive is positioned higher in the cabin closer to the roof 84.

Referring now to FIGS. 1F and 1G, another example of a vent 42′ is illustrated in a front perspective view and a side cutaway view respectively. The vent 42′ has vertical louvers 44V and horizontal louvers 44H, the angular positions of which are controlled by the actuator 46. In this example, the horizontal louvers 44H are in front of the vertical louvers 44V. However, the louver positions may be changed. The horizontal louvers 44H can direct the air upward or downward in the cabin 22. The vertical louvers 44V direct the air rightward and leftward relative to the front of the vent 42′. A damper door 45 opens and closes to block air from exiting the vent 42′ when commanded by the control system such as when the purge strategy is active. The damper door 45 may be used or louvers that seal well may also be used in the alternative.

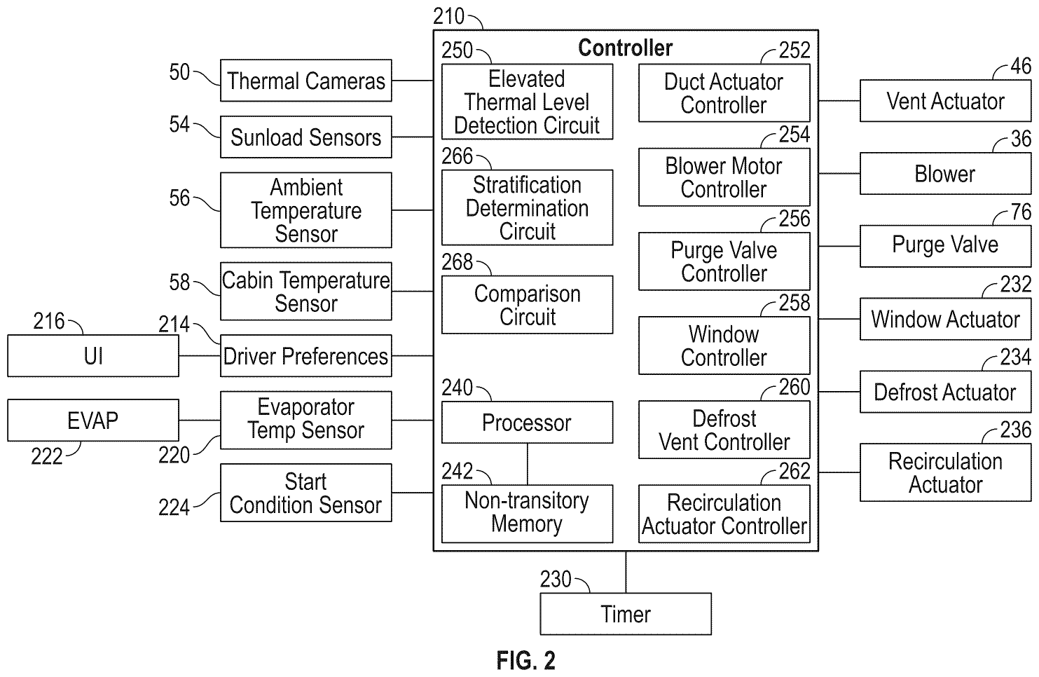

Referring now to FIG. 2, the system may be controlled in various states by a controller 210 which is coupled to the various sensors. FIG. 2 is simplified in that multiple sensors of the different types may be employed in various locations as illustrated best in FIGS. 1A and 1D. The controller 210 is programmed to perform various determinations and generate various intermediate signals used to ultimately control the climate control system. For example, the movement between the various operational states may be determined. The sensors include the sun load sensors 54, the cabin temperature sensors 58 (58A-58D), and the thermal cameras 50.

The controller 210 may be coupled to driver preferences 214 that may be selected by a user interface 216. For example, driver preferences 214 may include the desired temperature of the cabin 22 of the vehicle when the last phase of the operation of the system is performed. Driver preferences 214 may be controlled through the user interface 216 which may be touch screen, dials, buttons or the like. The driver preferences 214 may include, but are not limited to, the desired position or amount of blowing of the vent air to the facial region of an occupant, the temperature of the occupant, a temperature differential for the occupant, such as but not limited to warmer at the feet and cooler at the face.

The controller 210 is also coupled to an evaporator temperature sensor 220. The evaporator temperature sensor 220 is in communication with the evaporator 222 that is disposed within the primary duct 38. That is, the blower 36 draws air over the surfaces of the evaporator 222 to cool the air within the primary duct 38 during the air conditioning process. The evaporator temperature sensor 220 is coupled to the evaporator 222 so that the temperature of the evaporator is known. Examples of the evaporator 222 are set below.

The controller 210 may also sense the start condition at a start condition sensor 224 of the vehicle 10. Rotating an ignition switch or pushing an ignition button may start the vehicle 10 and thus the starting condition may be sensed at the starting condition sensor 224, the signal of which is communicated to the controller 210. The start condition sensor 224 may be sensed in either an internal combustion engine vehicle or an electric vehicle or a hybrid vehicle.

A timer 230 may also be coupled to the controller 210. Although the timer 230 is illustrated outside the controller 210, the timer 230 may be incorporated therein.

The controller 210 may be used to control various actuators and functions within the vehicle 10 so that the different states may be achieved. The vent actuator 46, the blower motor 36, the duct purge valve 76 may all be controlled by the controller 210. Likewise, the window actuator 232 and a defrost actuator 234 may be controlled. The window actuator 232 may represent a plurality of actuators, one of which is coupled to each of the windows 20A-20D. The defrost actuator 234 may be used to direct air through the defrost duct 74 illustrated in FIG. 1D. By directing air through the defrost duct 74 by way of the defrost actuator 234, destratification may be enhanced.

The controller 210 may have various states that are described in greater detail below.

The controller 210 has various sub controllers or circuits therein. In general, the controller 210 has a processor 240 that may be microprocessor based. One or more processors 240 may be represented by the processor 240. The processor 240 is in communication with a non-transitory memory 242 that stores commands that allow the processor 240 to perform various functions.

The controller 210, as mentioned above, is used to perform various functions. An elevated thermal level detection circuit 250 is used to determine an elevated thermal level within the vehicle 10. In one example, the amount of solar saturation on the instrument panel surface is used to determine an elevated thermal level. As mentioned above, a sun load sensor 54 may be located on the top of the instrument panel. However, the elevated thermal level may be determined in other ways including from one or more images from one or more of the thermal cameras 50 or measuring various temperature sensors or sun load sensors of the vehicle. By providing an indication of surface saturation, the elevated thermal level detection circuit 250 is used as an input to control the vent actuator 46 using the duct actuator controller 252 and controlling the blower 36 by the blower motor controller 254. As described in greater detail below, the duct actuator controller 252 may control the vent to close and the blower 36 to turn on. Likewise, a purge valve controller 256 may control the operation of the purge valve to an open position to allow air to be purged from the primary duct 38 into the purge duct 72. A window controller 258 is used to control the window actuator 232. To increase the amount of cooling, the window controller 258 may move the window to a slightly open position to allow air to be vented therefrom. A defrost vent controller 260 is used to control the defrost actuator 234 to direct air through the defrost duct 74 described above.

The controller 210 may also have a stratification determination circuit 266. The stratification determination circuit 266 is used to determine the stratification of air within the cabin 22 of the vehicle and when the air in the cabin 22 is de-stratified. As mentioned above, the temperature sensors 258A-258D may determine stratification or destratification of the cabin. Likewise, images from the thermal camera 50 may also be used to determine stratification and destratification. Stratification and destratification may be determined using a temperature differential between various temperature sensors 58A-58D. In one example, the stratification may be determined when the difference between two or more sensors is above a differential temperature threshold. That is, the difference of temperature sensed by the temperature sensor 58A may be compared with another temperature indicated by another one of the temperature sensors such as the temperature at temperature sensor 58C or temperature sensor 58D. When the differential temperature is above the temperature differential threshold, stratification is present. When the temperature differential is less than the temperature differential threshold, destratification has occurred. One example of the temperature differential threshold is 2 degrees Fahrenheit.

The controller 210 also includes a comparison circuit 268. The comparison circuit 268 may be used to perform various comparisons such as the comparison of the temperatures mentioned immediately above. The cabin temperature may also be used to determine the amount of heat or thermal level within the vehicle and therefore the surface saturation of the instrument panel from the elevated thermal level detection circuit 250. The comparison circuit 268 may also compare the outside or ambient temperature from the ambient temperature sensor 56 with a temperature from one or more temperature sensors 58A-58D such as a low mounted temperature sensor 58C or 58C. The comparison circuit 268 may also be used to compare a time period from the start of a blower 36 to determine whether predetermined amount of time so that a sufficient amount of air has been used to flush the ducts 38. The comparison circuit 268 may also be used to determine the solar load and determine whether the solar load is greater than a solar load threshold. In addition, the evaporator temperature may be compared to an evaporator temperature threshold at the comparison circuit 268 to determine whether a direct cooling state may be entered as described in greater detail below.

A recirculation actuator 236 may be used to control the source of the recirculation air of the vehicle. The recirculation actuator 236 may be a valve or door used for communicating air to the primary duct 38 from the recirculation duct 410 or the fresh air inlet duct 414 (of FIG. 4). A recirculation actuator controller 262 controls the recirculation actuator 236 to provide either cabin air from the cabin 22 (recirculated cabin air) or fresh air from outside the vehicle to the primary duct 38. That is, the coolest air from either outside the vehicle (determined from the ambient air temperature sensor 56) or from within the cabin (from one or more temperature sensors 58A-58D) may be used as the source of air.

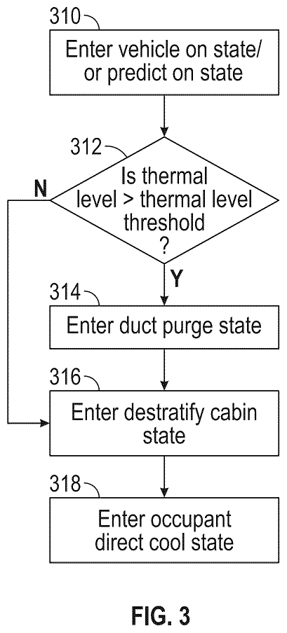

Referring now to FIG. 3, a high-level flowchart of a method of operating a system is set forth. In step 310, the vehicle enters the on or start condition state. A prediction of the on-state may also be provided. For example, the system may activate in an electric vehicle as the driver or person with the electronic key approaches the vehicle. The start condition sensor 224 may be used in this determination. Step 310 initiates the process which may include reading various data from the sensors.

In step 312, the thermal level within the vehicle is determined. The thermal level may be determined by the solar load on the instrument panel as determined in the elevated thermal level detection circuit 250. Other indications of the thermal level may include the temperature at one or more of the temperature sensors within the vehicle. The thermal level may also be indicated by an image from one or more of the thermal cameras 50. When the thermal level is greater than thermal level threshold in step 312, a duct purge state is entered in step 314. The duct purge state replaces the heated air within the duct and closes the vent as described in greater detail below.

After step 314, the destratification state for air in the cabin 22 is entered in step 316. The destratification state in step 316 is also entered when the thermal level is not greater than a thermal level threshold.

In step 316, the cabin 22 is de-stratified by operating the blower 36 and directing the outlets and the desired direction as described in greater detail below.

After step 316, the occupant direct cool state is entered in step 318. The occupant direct cool state directly cools the occupant with chilled air.

Referring now to FIG. 4, a simplified version of a cabin cooling system 400 is illustrated. In this example, a recirculation air inlet duct 410 is coupled to the recirculation actuator 236 such as a recirculation valve which, in turn, is coupled to a fresh air inlet 414. The recirculation actuator 236 is controlled by way of the recirculation actuator controller 262 of the controller 210 to select either the air from within the cabin 22 or the air external to the vehicle 10 through the fresh air inlet 414. The blower 36 draws the air from either the recirculation air inlet 410 or the fresh air inlet 414 and mover the air within the primary duct. The evaporator 222 cools the air when the evaporator 222 has been cooled for a sufficient amount of time. That is, the thermal mass of the evaporator 222 takes some finite time to achieve cool surfaces. The duct purge valve 76 is controlled by the purge valve controller 256 of the controller 210 as described above and in greater detail below. Ultimately, the duct purge valve 76 allows air to exit to the cabin 22 through the vents 42 or exit through the purge duct 72 and external to the cabin of the vehicle 10 through the purge outlet 418. As mentioned above, the purge duct 72 may have an alternate path 72′ to a location within the vehicle cabin 22 not acting on the occupant.

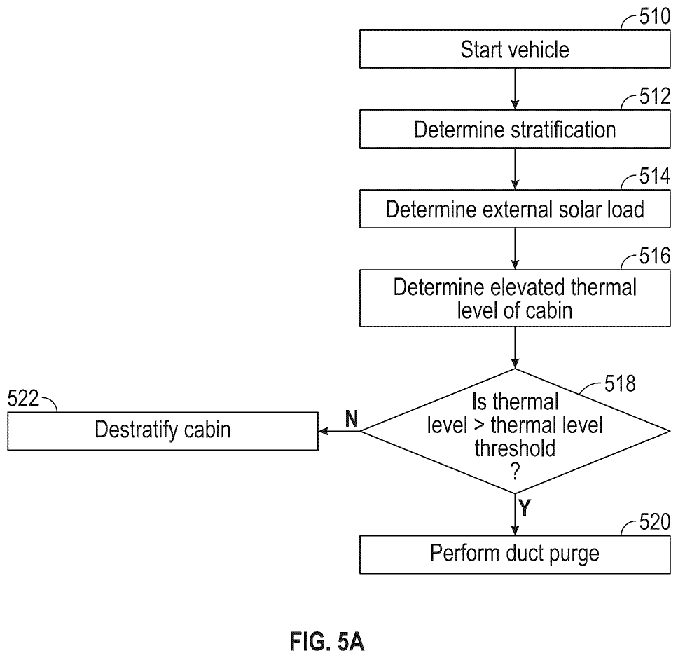

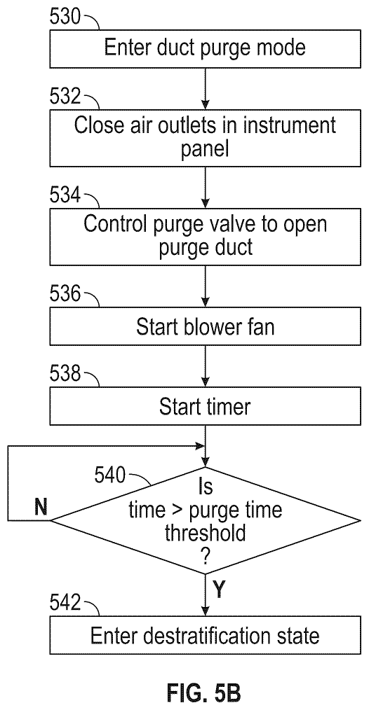

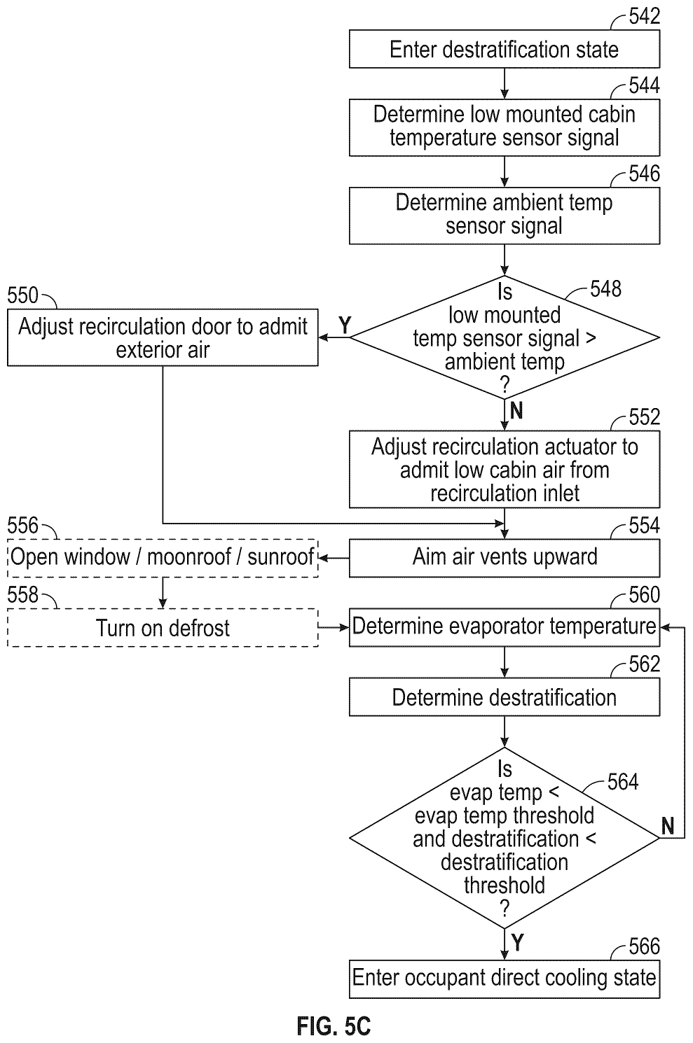

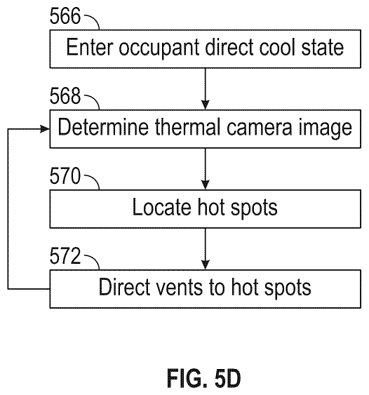

Referring now to FIG. 5A, the vehicle 10 is started in step 510 and the process is started. In step 512, the stratification of cabin air within the cabin 22 is determined. As mentioned above, the stratification may correspond to the difference between at least two different temperature sensors. In step 514, the external solar load on the vehicle is determined using the solar load sensor 54 described above. Based upon the stratification determined in the stratification step 512 and the external solar load determined in step 514, step 516 determines an elevated thermal level within the vehicle 10. By way of example, the instrument panel circuit solar load may be determined. As mentioned above, steps 512 and 514 may not be used when a direct solar load sensor on the instrument panel is used. Other ways to determine thermal levels include but are not limited to the use of the temperature sensors 58A-58D.

After step 516, step 518 determines whether the thermal level such as the IP solar load is greater than a thermal level threshold such as an IP solar load threshold. When the IP solar load is greater than an IP threshold, the duct purge state is performed in step 520 to purge the primary duct 38 as described below in FIG. 5B. However, when the thermal level is not greater than the IP solar load threshold, step 522 de-stratifies the air in the cabin 22 as described below in FIG. 5C.

Referring now to FIG. 5B, the duct purge state is described. In step 530, the duct purge state is entered after FIG. 5A, step 520. In step 532, the air outlets, such as the louvers of the vents, are closed in the instrument panel or elsewhere. In step 534, the purge valve is controlled to open the purge duct. In step 536, the blower fan is started so that the heated air within the primary duct 38 is moved to begin to be replaced to start the purge process. In step 538, the timer 230 starts to measure the time period since starting of the blower as a measure of whether the air in the primary duct has been replaced. In step 540, when the time is not greater than a purge threshold time, step 540 continues in which the blower fan continues to operate, and the purge valve is continued to be open to allow the purging through the purge duct 72. In the duct purge process, fresh air is received through the fresh air inlet and routed through the recirculation door 412 through the blower 36 and the evaporator 222 so that fresh air is directed through the primary duct 38, through the duct purge valve 76, which is in the open state and through the purge duct 72. When the timer is greater than the purge time threshold in step 540, this indicates that the amount of volume within the purge duct has been achieved and therefore the air within the purge duct has been replaced. In step 542, a destratification state is entered as described in FIG. 5C.

Referring now to FIG. 5C, the destratification state is entered in step 542 as described above. After step 542, step 544 determines the temperature at the low mounted cabin temperature sensor. After step 544, step 546 determines the ambient temperature sensor signal and the ambient temperature corresponding thereto. In step 548, the low mounted temperature sensor signal is compared to the ambient temperature indicated by the ambient temperature signal to determine whether recirculation from the cabin 22 or through the fresh air inlet is to be used. That is, when the temperature from the low mounted temperature signal is greater than the ambient temperature, step 550 adjusts the recirculation actuator 236 to open a pathway so that fresh air is communicated to the blower 36 through the fresh air inlet 414. In step 548, when the low mounted temperature signal is not greater than the ambient temperature, meaning that the cabin temperature is lower than the temperature external to the vehicle, step 552 is performed. In step 552, the recirculation actuator 236 is adjusted to admit the air from the exterior of the cabin through the recirculation air inlet 412. After step 550 and 552, step 554 aims the louvers 44 of the vents 42 in an upward direction to initiate the recirculation process and reduce the amount of stratification. In step 556, an optional step of opening the window or sunroof/moonroof may be executed by the system. That is, the window actuator 232 illustrated in FIG. 2 may be used to open a window opening. The window or sunroof may be open a small amount to provide an air path to the exterior of the vehicle. After step 556, another optional step of turning on the defroster may be performed. The defroster allows the blower 36 to direct air through the defrost duct 74 along the windshield 16 of the vehicle which, in turn, directs the air toward the vehicle roof 84.

After step 558, the evaporator temperature is determined.

After step 560, the amount of destratification is determined in step 562. As mentioned above, the amount of stratification or destratification may be based upon the differential temperature between a temperature sensor located high in the vehicle and a temperature sensor low in the vehicle. Of course, more than two sensors may be used to determine destratification. Alternatively, the thermal camera may be used to determine stratification/destratification. After step 562, step 564 determines whether the evaporator temperature is less than an evaporator temperature threshold and whether the destratification is less than a destratification threshold. The evaporator temperature is not greater than the evaporator temperature and the destratification is not greater than the destratification threshold, step 560 continues monitoring the process. The process continues to operate the blower fan to direct the vents and the louvers therein to circulate air within the vehicle. When the evaporator temperature is less than the evaporator threshold and the destratification is less than the destratification threshold, step 566 ends the destratification state and enters a direct cooling state. The direct cooling state is entered when the vehicle cabin 22 is sufficiently stratified.

Referring now to FIG. 5D, step 566 enters the occupant direct cool state as indicated in FIG. 5C step 566. In step 568, the thermal camera image is obtained. Hotspots may be located in step 570 based upon the thermal image and the vents are directed to the hotspots in step 572. Knowledge of the occupant thermal state, clothing coverage, position of the occupant and the like may be used as set forth in U.S. Applications (Attorney dockets 711881US and 712038US), the disclosures of which are incorporated by reference herein. As mentioned briefly above, the hotspots are the hotspots on an occupant of the vehicle. For example, the face and head area of the vehicle are typical hotspots. Determining where the sun is shining directly on an occupant may be used to determine where to direct the vents. The vents may be directed by rotating the vents and opening and closing the louvers to direct air into the desired position to cool the occupant.

By moving through the various states described in FIGS. 5A-5D, the cabin 22 of the vehicle may be efficiently cooled and provide rapid comfort to the occupant of the vehicle. The system is particularly useful for electric vehicles because of the efficiency of the system. However, internal combustion vehicles and hybrid vehicles may also benefit from the implementation of this system.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method comprising:
determining an elevated thermal level within a cabin of a vehicle;
opening a duct purge valve based on the elevated thermal level; and
communicating air through a primary duct to a purge duct through the purge valve.

2. The method of claim 1 wherein determining elevated thermal level comprises determining a cabin temperature.

3. The method of claim 1 wherein determining elevated thermal level comprises determining a solar load on an instrument panel of the vehicle.

4. The method of claim 1 wherein determining elevated thermal level comprises determining the elevated thermal level using a thermal camera.

5. The method of claim 1 wherein communicating air through the primary duct to the purge duct through the purge valve comprises communicating air through the duct purge valve and the purge duct for a predetermined time.

6. The method of claim 1 wherein communicating air through the primary duct to the purge duct through the purge valve comprises communicating air through the duct purge valve and the purge duct until a predetermined volume of air in the primary duct is purged.

7. The method of claim 6 wherein after the primary duct is purged, de-stratifying the cabin of the vehicle.

8. The method of claim 7 wherein de-stratifying comprises determining stratification of the cabin based on a thermal image.

9. The method of claim 7 wherein de-stratifying comprises determining stratification of the cabin based on a temperature sensors in the cabin of the vehicle.

10. The method of claim 7 wherein de-stratifying comprises directing air from a controllable vent toward a roof, closing the purge valve and selecting a coolest of ambient air or recirculated cabin air to be communicated to a blower.

11. The method of claim 10 further comprising ending de-stratifying when the cabin air is de-stratified and an evaporator temperature is below an evaporator threshold.

12. The method of claim 11 wherein after de-stratifying, directing the vent toward an occupant.

13. A system comprising:
an elevated thermal level detection circuit determining an elevated thermal level within a cabin of a vehicle;
a primary duct having a controllable vent and a duct purge valve;
a purge duct coupled to the primary duct at the duct purge valve;
a blower moving air within the primary duct; and
a controller, in a duct purge state, closing the controllable vent and controlling the duct purge valve so air through the primary duct is communicated through the purge valve to the purge duct.

14. The system of claim 13 wherein the elevated thermal level detection circuit is coupled to a thermal camera and determines then elevated thermal level based on a thermal image from the thermal camera.

15. The system of claim 13 wherein the elevated thermal level detection circuit determines the elevated thermal level based on a solar load of an instrument panel.

16. The system of claim 13 wherein the controller performs the duct purge state for a predetermined amount of time.

17. The system of claim 16 wherein, after the predetermined amount of time, the controller enters a destratification state by directing the controllable vent to direct the air toward a roof of the vehicle and closes the duct purge valve.

18. The system of claim 17 further comprising a recirculation valve, a cabin temperature sensor generating a cabin temperature signal and ambient temperature sensor generating an ambient temperature signal, said controller controlling the recirculation valve to recirculate cabin air or ambient air based on the cabin temperature signal and the ambient temperature signal in the destratification state.

19. The system of claim 18 further comprising an evaporator and an evaporator temperature sensor generating an evaporator temperature signal, said controller determining destratification and based on destratification and the evaporator temperature signal, entering an occupant direct cool state.

20. The system of claim 19 wherein the controller, in the direct cool state, directs the controllable vent toward a hot spot of vehicle occupant based on a thermal image form a thermal camera.
